(19) United States
(12) Patent Application Publication
(10) Pub. No.: US 2013/0148120 A1
(43) Pub. Date: Jun. 13, 2013

(54) OVERLAY MEASURING METHOD

(71) Applicants: Yosuke OKAMOTO, Mie (JP); Taketo KURIYAMA, Mie (JP)

(72) Inventors: Yosuke OKAMOTO, Mie (JP); Taketo KURIYAMA, Mie (JP)

(73) Assignee: Kabushiki Kaisha Toshiba, Tokyo (JP)

(21) Appl. No.: 13/566,248

(22) Filed: Aug. 3, 2012

(30) Foreign Application Priority Data
Dec. 8, 2011 (JP) 2011-268742

(51) Int. Cl. G01B 11/14

(52) U.S. Cl. 356/401

(57) ABSTRACT

According to one embodiment, an overlay measuring method includes calculating a first symmetry center coordinate on a basis of reflected light from first and second overlay measurement marks formed by using a first layer, calculating a second symmetry center coordinate on a basis of reflected light from third and fourth overlay measurement marks by using a second layer, and calculating an overlay displacement amount in a predetermined direction between the first layer and the second layer on a basis of the first and second symmetry center coordinates, in which the first to fourth overlay measurement marks have a plurality of space widths or pattern widths in the predetermined direction.

### CROSS-REFERENCE TO RELATED APPLICATIONS

This application is based upon and claims the benefit of priority from Japanese Patent Application No. 2011-268742, filed on Dec. 8, 2011; the entire contents of which are incorporated herein by reference.

### FIELD

Embodiments described herein relate generally to an overlay measuring method.

### BACKGROUND

In a semiconductor manufacturing process using an exposure apparatus, exposure is performed after being aligned with a pattern formed in a previous process. Then, the overlay displacement amount between the exposed pattern (overlying pattern) and the underlying pattern is measured based on an image obtained by capturing an overlay measurement mark formed in the previous process and an overlay measurement mark formed in the exposure at the same time. Various patterns are used for the overlay measurement mark and typical examples thereof include a box-in-box type, a bar-in-bar type, a line and space type, and the like.

There is a growing need for such an overlay measurement mark to have an increased number of overlay measurement points arranged in a semiconductor chip, which conflicts with the progress in the scaling of the semiconductor chips. Therefore, scaling of an overlay measurement mark is progressing.

However, the quality of an overlay measurement mark and the periphery of the overlay measurement mark varies in some cases due to the scaling of the overlay measurement mark. As a result, problems may occur, such as erroneous measurement in overlay measurement and the failure to detect an unexpectedly large overlay displacement.

Therefore, it is desired to perform overlay measurement with reduced erroneous measurement.

### BRIEF DESCRIPTION OF THE DRAWINGS

FIG. 1 is a diagram illustrating a configuration of an overlay displacement inspection apparatus;

FIG. 2A and FIG. 2B are diagrams illustrating a configuration of an overlay measurement mark according to a first embodiment;

FIG. 3A to FIG. 3C are diagrams illustrating a waveform example representing the reflectance and the degree of coincidence with respect to the overlay measurement mark according to the first embodiment;

FIG. 4A and FIG. 4B are diagrams illustrating a configuration of an overlay measurement mark according to a second embodiment;

FIG. 5A to FIG. 5C are diagrams illustrating a waveform example representing the reflectance and the degree of coincidence with respect to the overlay measurement mark according to the second embodiment;

FIG. 6A and FIG. 6B are diagrams illustrating a configuration of an overlay measurement mark according to a third embodiment;

FIG. 7A to FIG. 7C are diagrams illustrating a waveform example representing the reflectance and the degree of coincidence with respect to the overlay measurement mark according to the third embodiment;

FIG. 8A and FIG. 8B are diagrams illustrating a configuration of an overlay measurement mark according to a fourth embodiment;

FIG. 9A to FIG. 9C are diagrams illustrating a configuration of line patterns arranged in line pattern regions;

FIG. 10A to FIG. 10C are diagrams illustrating a waveform example representing the reflectance with respect to the overlay measurement mark according to the fourth embodiment; and

FIG. 11 is a diagram illustrating a configuration of an overlay measurement mark according to a fifth embodiment.

### DETAILED DESCRIPTION

In an overlay measuring method in embodiments, a first overlay measurement mark and a second overlay measurement mark are irradiated with illumination light and reflected light from the first and second overlay measurement marks is received. The first overlay measurement mark is a mark formed by using a first layer so that each line pattern of a first line pattern group extends in a direction parallel to a first direction in a substrate surface. The second overlay measurement mark is a mark that is formed by using the first layer and has point-symmetry with the first overlay measurement mark. A third overlay measurement mark and a fourth overlay measurement mark are irradiated with illumination light and reflected light from the third and fourth overlay measurement marks is received. The third overlay measurement mark is a mark formed by using a second layer so that each line pattern of a second line pattern group extends in a direction parallel to the first direction in the substrate surface. The fourth overlay measurement mark is a mark that is formed by using the second layer and has point-symmetry with the third overlay measurement mark. After irradiation with the illumination light, a first symmetry center coordinate with respect to the first and second overlay measurement marks in a second direction vertical to the first direction in the substrate surface is calculated. At this time, the first symmetry center coordinate is calculated based on an intensity profile of reflected light from each line pattern in the first and second overlay measurement marks. Moreover, a second symmetry center coordinate with respect to the third and fourth overlay measurement marks in the second direction in the substrate surface is calculated. At this time, the second symmetry center coordinate is calculated based on an intensity profile of reflected light from each line pattern in the third and fourth overlay measurement marks. Thereafter, an overlay displacement amount in the second direction between a pattern formed by using the first layer and a pattern formed by using the second layer is calculated based on the first symmetry center coordinate and the second symmetry center coordinate. The first to fourth overlay measurement marks have a plurality of space widths or a plurality of pattern widths in the second direction.

An overlay measuring method according to the embodiments will be explained below in detail with reference to the accompanying drawings. The present invention is not limited to these embodiments.

### First Embodiment

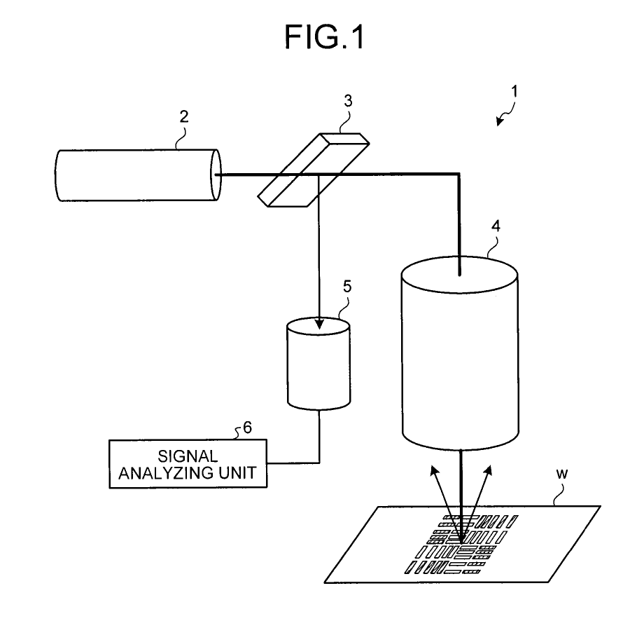

FIG. 1 is a diagram illustrating a configuration of an overlay displacement inspection apparatus. An overlay displacement inspection apparatus 1 is an apparatus that measures the overlay displacement amount (amount of positional displacement) between an overlay measurement mark (hereinafter, lower layer side marks 11) formed on the lower layer side and an overlay measurement mark (hereinafter, upper layer side marks 12) formed on the upper layer side. The upper layer side marks 12 are patterns formed in a process after forming the lower layer side marks 11 and are, for example, a resist pattern formed by using an exposure process and a development process. In the present embodiment, each of the lower layer side marks 11 and each of the upper layer side marks 12 is a mark having a line and space structure having a plurality of different pattern pitches (hereinafter, pitches).

The overlay displacement inspection apparatus 1 images the lower layer side marks 11 and the upper layer side marks 12 at the same time and measures the overlay displacement amount between the lower layer side marks 11 and the upper layer side marks 12 on the basis of the captured image.

The overlay displacement inspection apparatus 1 includes a measurement light source 2, a mirror 3, a microscope 4, an imaging optics 5, and a signal analyzing unit 6. The measurement light source 2 is a light source apparatus, such as a halogen lamp, and emits illumination light. The mirror 3 transmits the illumination light emitted from the measurement light source 2 and sends it to the microscope 4. The microscope 4 is an optical microscope or the like and causes a substrate, such as a wafer W, to be irradiated with the illumination light. Therefore, the lower layer side marks 11 and the upper layer side marks 12 formed on the wafer W and the peripheral region thereof are irradiated with the illumination light.

The illumination light (reflected light) reflected from the wafer W is reflected by the mirror 3 and is sent to the imaging optics 5. The imaging optics 5 generates an image from the reflected light by focusing the reflected light and sends the image to the signal analyzing unit 6.

The signal analyzing unit 6 converts the image, in which the lower layer side marks 11 and the upper layer side marks 12 are captured, into waveforms representing the reflectance. The signal analyzing unit 6 calculates origin coordinates O with respect to the lower layer side marks 11 on the basis of the waveform representing the reflectance of the lower layer side marks 11 and origin coordinates O with respect to the upper layer side marks 12 on the basis of the waveform representing the reflectance of the upper layer side marks 12. The signal analyzing unit 6 calculates the overlay displacement amount between the lower layer side marks 11 and the upper layer side marks 12 on the basis of the origin coordinates O with respect to the lower layer side marks 11 and the origin coordinates O with respect to the upper layer side marks 12.

An overlay measurement mark 10, which will be described later, is composed of the lower layer side marks 11 and the upper layer side marks 12. The overlay measurement mark 10 is formed, for example, in a plurality of shots on the wafer W. Moreover, the overlay measurement mark 10 is formed at a plurality of locations in each shot. The overlay displacement inspection apparatus 1 calculates the distribution of the overlay displacement amount on the wafer W by using the overlay measurement marks 10.

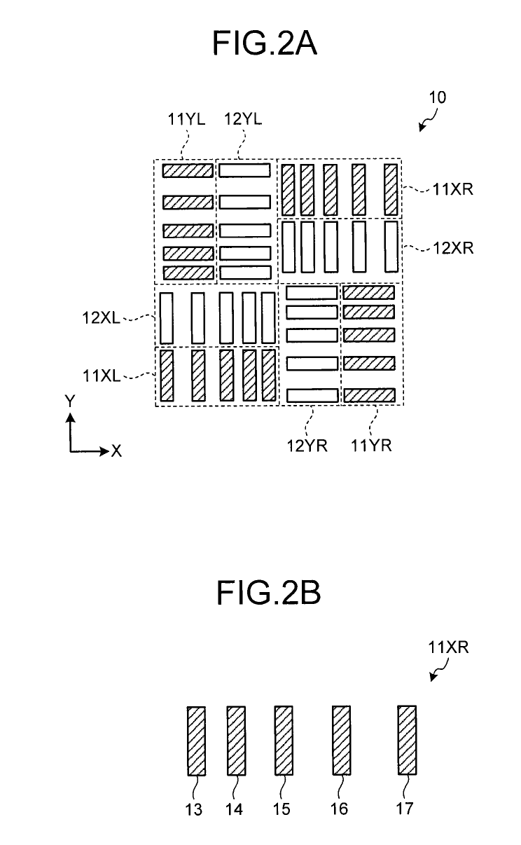

FIG. 2A and FIG. 2B are diagrams illustrating a configuration of the overlay measurement mark according to the first embodiment. FIG. 2A illustrates a top view of the overlay measurement mark 10 according to the first embodiment. The overlay measurement mark 10 is a line and space type mark and is, for example, an AIM (Advanced Imaging Metrology) mark. The overlay measurement mark 10 is formed by using lower layer side patterns and upper layer side patterns. For example, the lower layer side mark 11 and the upper layer side mark 12 are each formed such that the space widths in a line and space have at least two or more different dimensions.

The overlay measurement mark 10 includes lower layer side marks 11XR, 11YR, 11XL, and 11YL as the lower layer side marks 11 (Outer) and upper layer side marks 12XR, 12YR, 12XL, and 12YL as the upper layer side marks 12 (Inner). In the following, the lower layer side marks 11XR, 11YR, 11XL, and 11YL are called the lower layer side marks 11 in some cases. Moreover, the upper layer side marks 12XR, 12YR, 12XL, and 12YL are called the upper layer side marks 12 in some cases.

The lower layer side marks 11XR and 11XL are line and space patterns formed by arranging a plurality of line patterns, which extend in the Y direction, in parallel in the X direction. Moreover, the lower layer side marks 11YR and 11YL are line and space patterns formed by arranging a plurality of line patterns, which extend in the X direction, in parallel in the Y direction. The lower layer side mark 11XR and the lower layer side mark 11XL have point-symmetry about the origin coordinates O, which will be described later, being a symmetry center. In a similar manner, the lower layer side mark 11YR and the lower layer side mark 11YL have point-symmetry about the origin coordinates O being a symmetry center.

The upper layer side marks 12XR and 12XL are line and space patterns formed by arranging a plurality of line patterns, which extend in the Y direction, in parallel in the X direction. Moreover, the upper layer side marks 12YR and 12YL are line and space patterns formed by arranging a plurality of line patterns, which extend in the X direction, in parallel in the Y direction. The upper layer side mark 12XR and the upper layer side mark 12XL have point-symmetry about the origin coordinates O being a symmetry center. In a similar manner, the upper layer side mark 12YR and the upper layer side mark 12YL have point-symmetry about the origin coordinates O being a symmetry center.

For example, the lower layer side mark 11 is formed at a first position by using a first layer. Thereafter, the upper layer side mark 12 is formed at a second position by using a second layer, whereby the overlay measurement mark 10 using the first layer and the second layer is formed. Moreover, when forming the upper layer side mark 12 at the second position by using the second layer, the lower layer side mark 11 is formed at a third position by using the second layer in advance. Thereafter, the upper layer side mark 12 is formed at a fourth position by using a third layer, whereby the overlay measurement mark 10 using the second layer and the third layer is formed.

The configuration of the lower layer side marks 11XR, 11YR, 11XL, and 11YL and the upper layer side marks 12XR, 12YR, 12XL, and 12YL will be explained. The lower layer side marks 11XR, 11YR, 11XL, and 11YL and the upper layer side marks 12XR, 12YR, 12XL, and 12YL each have a similar configuration, therefore, the configuration of the lower layer side mark 11XR will be explained here.

FIG. 2B illustrates a top view of the lower layer side mark according to the first embodiment. The lower layer side mark 11XR includes five line patterns 13 to 17. The line pattern 13 is closest to the origin coordinates O of the overlay measurement mark 10, the line pattern 14 is second closest to the origin coordinates O, and the line pattern 15 is third closest to the origin coordinates O. Moreover, the line pattern 16 is fourth closest to the origin coordinates O of the overlay measurement mark 10 and the line pattern 17 is farthest from the origin coordinates O. In other words, the line patterns 13 to 17 are arranged in the order of the line patterns 13, 14, 15, 16, and 17 in a direction away from the origin coordinates O of the overlay measurement mark 10.

The line patterns 13 to 17 are such that the line pattern widths (lateral direction) are approximately the same dimension and the space widths between the line patterns are set to have a plurality of dimensions. For example, the line patterns 13 to 17 have the same shape and size and each line pattern is arranged such that the distance (space width) between the line patterns increases as the distance from the origin coordinates O of the overlay measurement mark 10 increases. Specifically, among the space widths, the space width between the line pattern 13 closest to the origin coordinates O of the overlay measurement mark 10 and the line pattern 14 second closest to the origin coordinates O is the smallest. The space width between the line pattern 14 and the line pattern 15 is the second smallest and the space width between the line pattern 15 and the line pattern 16 is the third smallest. The space width between the line pattern 16 and the line pattern 17 is the largest.

In a similar manner, each line pattern is arranged in the lower layer side marks 11YR, 11XL, and 11YL and the upper layer side marks 12XR, 12YR, 12XL, and 12YL in such a way that a line pattern closer to the origin coordinates O has a shorter distance from an adjacent line pattern.

Each line pattern may be arranged in the lower layer side marks 11 and the upper layer side marks 12 in such a way that a line pattern closer to the origin coordinates O has a longer distance from an adjacent line pattern. Moreover, each line pattern may be arranged to have various space widths regardless of the distance from the origin coordinates O.

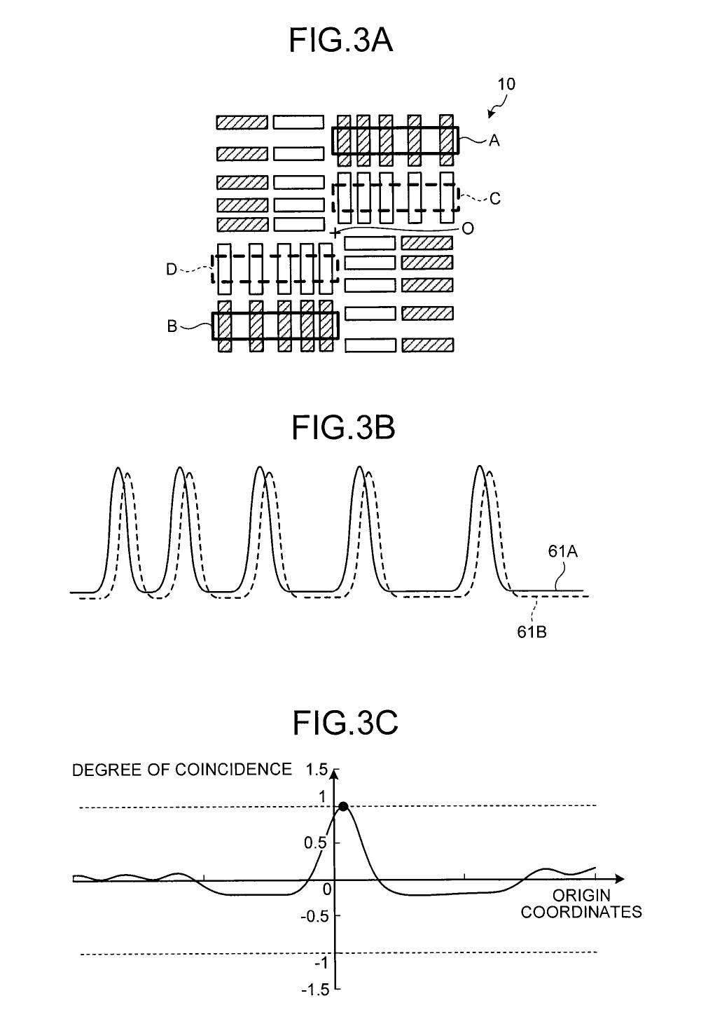

Next, the measuring method of the overlay displacement amount will be explained. FIG. 3A to FIG. 3C are diagrams for explaining the measuring method of the overlay displacement amount and illustrating a waveform example representing the reflectance and the degree of coincidence with respect to the overlay measurement mark according to the first embodiment. FIG. 3A illustrates a ROI (Region of Interest) that is a measurement region of the overlay displacement amount and the origin coordinates O of the overlay measurement mark 10. In this embodiment, a measurement region A of the lower layer side mark 11XR, a measurement region B of the lower layer side mark 11XL, a measurement region C of the upper layer side mark 12XR, and a measurement region D of the upper layer side mark 12XL are illustrated as a ROI.

The overlay displacement inspection apparatus 1 calculates origin coordinates O1 (not shown) of a mark composed of the lower layer side marks 11XR and 11XL and origin coordinates O2 (not shown) of a mark composed of the upper layer side marks 12XR and 12XL to measure the overlay displacement amount in the X direction between the lower layer side marks 11 and the upper layer side marks 12.

Specifically, to calculate the origin coordinates O1 of the lower layer side marks 11XR and 11XL, the signal analyzing unit 6 of the overlay displacement inspection apparatus 1 moves the origin coordinates O in the X direction on the overlay measurement mark 10 in a state where the relative positions of the origin coordinates O and the measurement regions A and B are fixed. Then, the signal analyzing unit 6 derives the reflectance in the measurement region A on the basis of an image in the measurement region A and derives the reflectance in the measurement region B on the basis of an image in the measurement region B for each position of the origin coordinates O. In this way, waveforms 61A and 61B representing the reflectance as shown in FIG. 3B are derived.

Furthermore, the signal analyzing unit 6 calculates the degree of coincidence (correlation value) between the waveform 61A representing the reflectance and the waveform 61B representing the reflectance for each position of the origin coordinates O. In this way, information on the degree of coincidence between the waveform 61A representing the reflectance and the waveform 61B representing the reflectance as shown in FIG. 3C is derived.

In the graph in FIG. 3C, the horizontal axis indicates the origin coordinates O and the vertical axis indicates the degree of coincidence. The signal analyzing unit 6 uses the position of the origin coordinates O having the highest degree of coincidence among the degree of coincidence derived for each position of the origin coordinates O as the origin coordinates O1 of the lower layer side marks 11XR and 11XL. In other words, when the origin coordinates O are moved in the X direction, the origin coordinates O having the greatest correlation between the waveforms 61A and 61B, which are the intensity profile of the reflected light, are used as the origin coordinates O1.

Moreover, to calculate the origin coordinates O2 of the upper layer side marks 12XR and 12XL, the signal analyzing unit 6 moves the origin coordinates O in the X direction on the overlay measurement mark 10 in a state where the relative positions of the origin coordinates O and the measurement regions C and D are fixed. Then, the signal analyzing unit 6 derives a waveform 61C (not shown) representing the reflectance by deriving the reflectance on the basis of an image in the measurement region C for each position of the origin coordinates O. Moreover, the signal analyzing unit 6 derives a waveform 61D (not shown) representing the reflectance by deriving the reflectance on the basis of an image in the measurement region D for each position of the origin coordinates O.

Furthermore, the signal analyzing unit 6 calculates the degree of coincidence between the waveform 61C and the waveform 61D for each position of the origin coordinates O. The signal analyzing unit 6 uses the position of the origin coordinates O having the highest degree of coincidence among the degree of coincidence derived for each position of the origin coordinates O as the origin coordinates O2 of the upper layer side marks 12XR and 12XL.

Then, the signal analyzing unit 6 compares the origin coordinates O1 of the lower layer side marks 11XR and 11XL with the origin coordinates O2 of the upper layer side marks 12XR and 12XL and sets the difference therebetween as the overlay displacement amount in the X direction.

In a similar manner, the signal analyzing unit 6 calculates origin coordinates O3 (not shown) of the lower layer side marks 11YR and 11YL on the basis of the lower layer side marks 11YR and 11YL and calculates origin coordinates O4 (not shown) of the upper layer side marks 12YR and 12YL on the basis of the upper layer side marks 12YR and 12YL. Then, the origin coordinates O3 of the lower layer side marks 11YR and 11YL are compared with the origin coordinates O4 of the upper layer side marks 12YR and 12YL and the difference therebetween is set as the overlay displacement amount in the Y direction.

The signal analyzing unit 6 calculates the sum of the overlay displacement amount in the X direction and the overlay displacement amount in the Y direction as the overlay displacement amount between the patterns formed by using the lower layer film and the patterns formed by using the upper layer film.

If the line pattern widths and the space widths in the lower layer side marks are all the same, overlay erroneous measurement occurs in some cases, such as (1) 1 pitch displacement, (2) ½ pitch displacement, and (3) ¼ pitch displacement. The pitch is the sum value of adjacent line pattern width and space pattern width when a line pattern and a space pattern are arranged alternately.

(1) 1 pitch displacement is erroneous measurement that occurs when a quality failure or the like occurs in a line pattern. For example, if the line pattern widths and the space widths in the lower layer side marks are all the same, if a quality failure or the like occurs in one line pattern in the lower layer side mark, only four normal waveforms (mountains) appear as a waveform representing the reflectance. In such a case, the degree of coincidence is calculated by comparing four peaks of one lower layer side mark with five peaks of the other lower layer side mark. Therefore, a position displaced by 1 pitch in a line and space is determined as the origin coordinates O of the lower layer side marks in some cases.

Moreover, the lower layer side mark is actually displaced by 1 pitch with respect to the upper layer side mark in some cases. In such a case, if the line pattern widths and the space widths in the lower layer side marks are all the same, the overlay displacement amount may be determined as approximately zero even if the lower layer side mark is displaced by 1 pitch.

(2) ½ pitch displacement occurs, for example, when film unevenness is large or warpage of the wafer W is large. When there is film unevenness or warpage of the wafer W, a difference in lightness occurs in some cases between a line pattern and a space position depending on the position in the lower layer side mark. For example, in some cases, although a line pattern is lighter than a space position in one lower layer side mark, the line pattern is darker than the space position in the other lower layer side mark. In such a case, the line pattern is mistakenly recognized as space or vice versa and, as a result, a position displaced by ½ pitch in a line and space is determined as the origin coordinates O of the lower layer side marks in some cases.

(3) ¼ pitch displacement occurs, for example, when the edge contrast of line patterns forming the lower layer side mark or the upper layer side mark is high. When the edge contrast of line patterns is high, each edge part of the line patterns becomes the peak of a waveform representing the reflectance. If the degree of coincidence between a waveform representing the reflectance of one lower layer side mark and a waveform representing the reflectance of the other lower layer side mark is calculated by using such a waveform representing the reflectance, a position displaced by ¼ pitch in a line and space is determined as the origin coordinates O of the lower layer side marks in some cases.

In contrast, in the present embodiment, the line patterns 13 to 17 in the lower layer side marks 11XR and 11XL and the upper layer side marks 12XR and 12XL are arranged to have two or more space widths. For example, in the case of the lower layer side mark 11XR illustrated in FIG. 2A, the lower layer side mark 11XR has a first space width between the line patterns 13 and 14, a second space width between the line patterns 14 and 15, a third space width between the line patterns 15 and 16, and a fourth space width between the line patterns 16 and 17.

Therefore, even if a quality failure or the like occurs in one line pattern in the lower layer side mark 11XR or the lower layer side mark 11XL, a position displaced by 1 pitch in a line and space is not determined as the origin coordinates O of the lower layer side marks 11XR and 11XL.

In a similar manner, even if there is film unevenness or warpage in the wafer W, a position displaced by ½ pitch in a line and space is not determined as the origin coordinates O of the lower layer side marks 11XR and 11XL.

Moreover, even if the edge contrast of line patterns is high, a position displaced by ¼ pitch in a line and space is not determined as the origin coordinates O of the lower layer side marks 11XR and 11XL.

This is because the line patterns 13 to 17 are arranged with various space widths and therefore the degree of coincidence between the waveform 61A representing the reflectance and the waveform 61B representing the reflectance becomes extremely small in a state where there is a displacement of 1 pitch, ½ pitch, or ¼ pitch. In other words, when the overlay displacement amount is calculated by using the lower layer side marks 11XR and 11XL, only one peak of the degree of coincidence appears at the position (position of the correct origin coordinates O) with no pitch displacement. Therefore, the risk of erroneous measurement when the overlay displacement amount is measured is reduced.

In this manner, in the present embodiment, because the line patterns 13 to 17 of the lower layer side marks 11XR and 11XL are arranged with various space widths, erroneous measurement (measurement jump), which may occur depending on the quality of the overlay measurement mark 10 and the periphery of the overlay measurement mark 10, can be prevented. Moreover, an unexpectedly large overlay displacement can be detected.

Formation of the lower layer side marks 11 and the upper layer side marks 12 and measurement of the overlay displacement amount by the overlay displacement inspection apparatus 1 are performed, for example, for each layer in a wafer process. When manufacturing a semiconductor device (semiconductor integrated circuit), the lower layer side marks 11 and the upper layer side marks 12 are formed on various layers, whereby the overlay measurement mark 10 is formed of the lower layer side marks 11 and the upper layer side marks 12.

Specifically, the lower layer film is formed on the wafer W and a lower-layer-side circuit pattern and the lower layer side marks 11 are formed by using the lower layer film. Furthermore, the upper layer film is formed on the wafer W. Thereafter, resist is applied to the wafer W, the wafer W to which the resist is applied is exposed by using a mask, and thereafter, the wafer is developed to form a resist pattern on the wafer. At this time, a circuit pattern and the upper layer side marks 12 are formed as the resist pattern. Then, the overlay displacement amount between the upper layer side marks 12 and the lower layer side marks 11 is measured by comparing the origin coordinates O of the lower layer side marks 11 and the upper layer side marks 12.

Thereafter, if the overlay displacement amount is within the allowable range, the upper layer film is etched with the resist pattern as a mask. Consequently, an upper-layer-side circuit pattern using the upper layer film is formed on the wafer W. If the overlay displacement amount exceeds the allowable range, after stripping the resist pattern on the wafer W, application of resist to the wafer W and formation of the resist pattern are repeated until the overlay displacement amount falls within the allowable range. When manufacturing a semiconductor device, formation of the lower layer film, formation of the lower-layer-side circuit pattern and the lower layer side marks 11 using the lower layer film, formation of the upper layer film, application of resist, formation (exposure and development) of the upper-layer-side circuit pattern and the upper layer side marks 12 using the resist pattern, measurement of the overlay displacement amount, etching, and the like described above are repeated for each layer.

The arrangement of the lower layer side marks 11 and the upper layer side marks 12 of the overlay measurement mark 10 is not limited to that shown in FIG. 2A and FIG. 2B. Moreover, the number of the line patterns of the lower layer side mark 11 (for example, the lower layer side mark 11XR) and the upper layer side mark 12 is not limited to five as long as it is three or more.

In this manner, according to the first embodiment, because the lower layer side marks 11 and the upper layer side marks 12 are such that the line pattern widths are the same and the space widths have at least two or more different dimensions, occurrence of a spurious peak in a correlation graph of the reflectance can be suppressed. As a result, erroneous measurement of the overlay displacement amount can be reduced. Therefore, the measurement robustness using fine marks can be improved.

### Second Embodiment

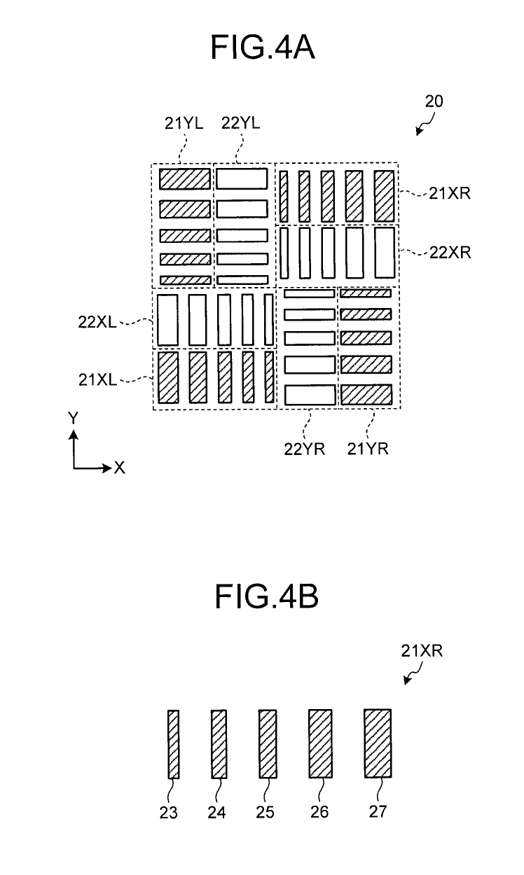

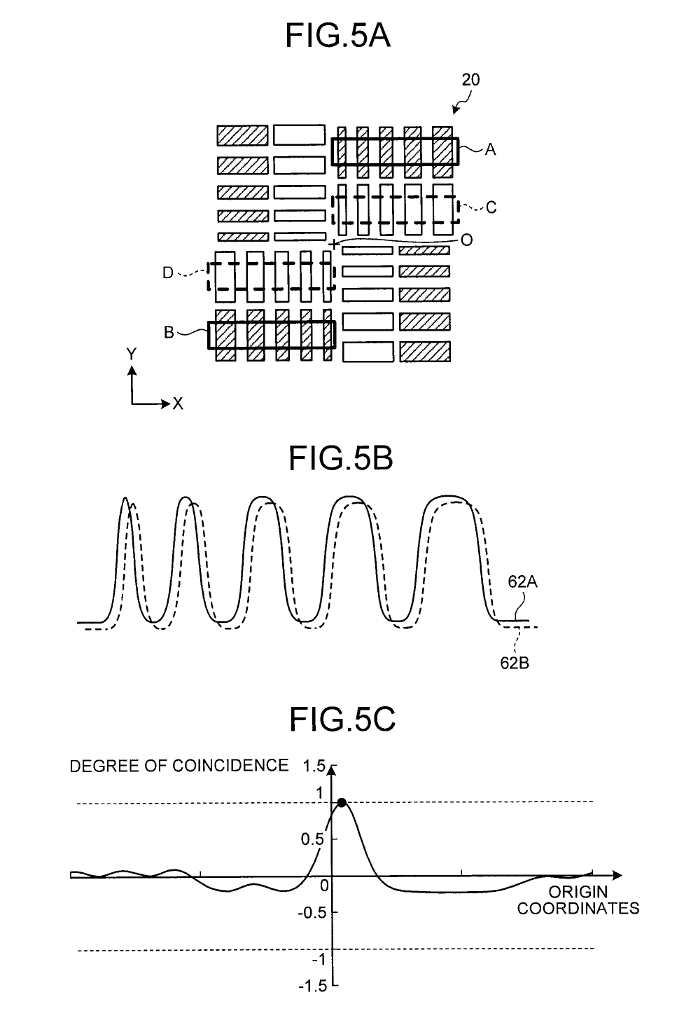

Next, the second embodiment of this invention will be explained with reference to FIG. 4A and FIG. 4B and FIG. 5A to FIG. 5C. In the second embodiment, the lower layer side marks 11 and the upper layer side marks 12 are such that the space widths are the same and the line pattern widths have at least two or more different dimensions.

FIG. 4A and FIG. 4B are diagrams illustrating a configuration of an overlay measurement mark according to the second embodiment. FIG. 4A illustrates a top view of an overlay measurement mark 20 according to the second embodiment. The overlay measurement mark 20 is an AIM mark or the like and is formed by using lower layer side patterns and upper layer side patterns. The lower layer side mark 11 and the upper layer side mark 12 are each a line and space type mark and are each formed such that the line pattern widths have at least two or more different dimensions.

The overlay measurement mark 20 includes lower layer side marks 21XR, 21YR, 21XL, and 21YL as the lower layer side marks 11 and upper layer side marks 22XR, 22YR, 22XL, and 22YL as the upper layer side marks 12. In the following, the lower layer side marks 21XR, 21YR, 21XL, and 21YL are called the lower layer side marks 11 in some cases. Moreover, the upper layer side marks 22XR, 22YR, 22XL, and 22YL are called the upper layer side marks 12 in some cases.

The lower layer side marks 21XR and 21XL are line and space patterns formed by arranging a plurality of line patterns, which extend in the Y direction, in parallel in the X direction. Moreover, the lower layer side marks 21YR and 21YL are line and space patterns formed by arranging a plurality of line patterns, which extend in the X direction, in parallel in the Y direction.

The upper layer side marks 22XR and 22XL are line and space patterns formed by arranging a plurality of line patterns, which extend in the Y direction, in parallel in the X direction. Moreover, the upper layer side marks 22YR and 22YL are line and space patterns formed by arranging a plurality of line patterns, which extend in the X direction, in parallel in the Y direction.

The lower layer side marks 21XR, 21XL, 21YR, and 21YL and the upper layer side marks 22XR, 22XL, 22YR, and 22YL in the present embodiment are arranged at positions similar to the lower layer side marks 11XR, 11XL, 11YR, and 11YL and the upper layer side marks 12XR, 12XL, 12YR, and 12YL in the first embodiment, respectively.

The configuration of the lower layer side marks 21XR, 21YR, 21XL, and 21YL and the upper layer side marks 22XR, 22YR, 22XL, and 22YL will be explained. The lower layer side marks 21XR, 21YR, 21XL, and 21YL and the upper layer side marks 22XR, 22YR, 22XL, and 22YL each have a similar configuration, therefore, the configuration of the lower layer side mark 21XR will be explained here.

FIG. 4B illustrates a top view of the lower layer side mark according to the second embodiment. The lower layer side mark 21XR includes five line patterns 23 to 27. The line pattern 23 is closest to origin coordinates O of the overlay measurement mark 20, the line pattern 24 is second closest to the origin coordinates O, and the line pattern 25 is third closest to the origin coordinates O. Moreover, the line pattern 26 is fourth closest to the origin coordinates O of the overlay measurement mark 20 and the line pattern 27 is farthest from the origin coordinates O. In other words, the line patterns 23 to 27 are arranged in the order of the line patterns 23, 24, 25, 26, and 27 in a direction away from the origin coordinates O of the overlay measurement mark 20.

The line patterns 23 to 27 are arranged such that the space widths between the line patterns are approximately the same dimension and the line pattern widths are set to have a plurality of dimensions. For example, the line patterns 23 to 27 are arranged such that the line pattern width increases as the distance from the origin coordinates O of the overlay measurement mark 20 increases. Specifically, among the line pattern widths, the line pattern width of the line pattern 23 closest to the origin coordinates O of the overlay measurement mark 20 is the smallest. The line pattern width of the line pattern 24 is the second smallest and the line pattern width of the line pattern 25 is the third smallest. The line pattern width of the line pattern 26 is the fourth smallest and the line pattern width of the line pattern 27 is the largest.

In a similar manner, each line pattern is arranged in the lower layer side marks 21YR, 21XL, and 21YL and the upper layer side marks 22XR, 22YR, 22XL, and 22YL in such a way that a line pattern closer to the origin coordinates O has a smaller line pattern width.

Each line pattern may be arranged in the lower layer side marks 11 and the upper layer side marks 12 in such a way that a line pattern closer to the origin coordinates O has a larger line pattern width. Moreover, each line pattern may be arranged to have various line pattern widths regardless of the distance from the origin coordinates O.

Next, the measuring method of the overlay displacement amount will be explained. The overlay displacement inspection apparatus 1 measures the overlay displacement amount between the lower layer side marks 11 and the upper layer side marks 12 by a processing procedure similar to the first embodiment.

Specifically, the overlay displacement inspection apparatus 1 calculates origin coordinates O1 of the lower layer side marks 21XR and 21XL and origin coordinates O2 of the upper layer side marks 22XR and 22XL to measure the overlay displacement amount in the X direction between the lower layer side marks 11 and the upper layer side marks 12. When calculating the origin coordinates O1 of the lower layer side marks 21XR and 21XL, measurement regions A and B are set in the lower layer side marks 21XR and 21XL.

Then, the signal analyzing unit 6 obtains waveforms representing the reflectance in the measurement regions A and B on the basis of an image in each of the measurement regions A and B. FIG. 5A to FIG. 5C are diagrams illustrating a waveform example representing the reflectance and the degree of coincidence with respect to the overlay measurement mark according to the second embodiment. FIG. 5A illustrates a ROI that is a measurement region of the overlay displacement amount and the origin coordinates O of the overlay measurement mark 20. In this embodiment, the measurement region A of the lower layer side mark 21XR, the measurement region B of the lower layer side mark 21XL, a measurement region C of the upper layer side mark 22XR, and a measurement region D of the upper layer side mark 22XL are illustrated as a ROI. FIG. 5B illustrates a waveform 62A representing the reflectance in the measurement region A and a waveform 62B representing the reflectance in the measurement region B.

The signal analyzing unit 6 derives the reflectance in the measurement region A for each position of the origin coordinates O and derives the reflectance in the measurement region B for each position of the origin coordinates O. In this manner, the waveforms 62A and 62B representing the reflectance as shown in FIG. 5B are derived.

Furthermore, the signal analyzing unit 6 calculates the degree of coincidence between the waveform 62A representing the reflectance and the waveform 62B representing the reflectance for each position of the origin coordinates O. In this manner, information on the degree of coincidence between the waveform 62A representing the reflectance and the waveform 62B representing the reflectance as shown in FIG. 5C is derived. In the graph in FIG. 5C, the horizontal axis indicates the origin coordinates O and the vertical axis indicates the degree of coincidence. The signal analyzing unit 6 uses the position of the origin coordinates O having the highest degree of coincidence among the degree of coincidence derived for each position of the origin coordinates O as the origin coordinates O1 of the lower layer side marks 21XR and 21XL.

Moreover, when calculating the origin coordinates O2 of the upper layer side marks 22XR and 22XL, the measurement regions C and D are set in the upper layer side marks 22XR and 22XL. Then, a waveform 62C (not shown) representing the reflectance in the measurement region C and a waveform 62D (not shown) representing the reflectance in the measurement region D are derived by a processing procedure similar to the first embodiment. Furthermore, the signal analyzing unit 6 calculates the origin coordinates O2 of the upper layer side marks 22XR and 22XL on the basis of the waveform 62C and the waveform 62D.

Then, the signal analyzing unit 6 compares the origin coordinates O1 of the lower layer side marks 21XR and 21XL with the origin coordinates O2 of the upper layer side marks 22XR and 22XL and sets the difference therebetween as the overlay displacement amount in the X direction.

The overlay displacement inspection apparatus 1 measures the overlay displacement amount in the Y direction between the lower layer side marks 11 and the upper layer side marks 12 by a processing procedure similar to the first embodiment, therefore, explanation thereof is omitted.

In the present embodiment, the line patterns 23 to 27 in the lower layer side marks 21XR, 21XL, 21YR, and 21YL and the upper layer side marks 22XR, 22XL, 22YR, and 22YL are formed with two or more line pattern widths. For example, in the case of the lower layer side mark 21XR shown in FIG. 4A, the lower layer side mark 21XR is composed of the line pattern 23 having a first line pattern width, the line pattern 24 having a second line pattern width, the line pattern 25 having a third line pattern width, the line pattern 26 having a fourth line pattern width, and the line pattern 27 having a fifth line pattern width.

Therefore, in a similar manner to the first embodiment, it is prevented that a position displaced by 1 pitch, ½ pitch, or ¼ pitch in a line and space is determined as the origin coordinates O of the lower layer side marks 21XR and 21XL.

This is because the line patterns 23 to 27 are formed with various line pattern widths and therefore only one peak of the degree of coincidence appears at the position (position of the correct origin coordinates O) with no pitch displacement when the overlay displacement amount is measured by using the line patterns 23 to 27.

In this manner, in the present embodiment, because the line patterns 23 to 27 forming the lower layer side marks 11 and the upper layer side marks 12 are formed with various line pattern widths, erroneous measurement (measurement jump), which may occur depending on the quality of the overlay measurement mark 20 and the periphery of the overlay measurement mark 20, can be prevented. Moreover, an unexpectedly large overlay displacement can be detected.

The arrangement of the lower layer side marks 11 and the upper layer side marks 12 of the overlay measurement mark 20 is not limited to that shown in FIG. 4A and FIG. 4B. Moreover, the number of the line patterns of the lower layer side mark 11 (for example, the lower layer side mark 21XR) and the upper layer side mark 12 is not limited to five as long as it is two or more.

Moreover, in the present embodiment, a case in which the space widths in the lower layer side marks 11 and the upper layer side marks 12 are the same is explained, however, the lower layer side marks 11 and the upper layer side marks 12 may be such that the space widths have at least two or more different dimensions and the line pattern widths have at least two or more different dimensions.

In this manner, according to the second embodiment, because the lower layer side marks 11 and the upper layer side marks 12 are such that the space widths are the same and the line pattern widths have at least two or more different dimensions, erroneous measurement of the overlay displacement amount can be reduced.

### Third Embodiment

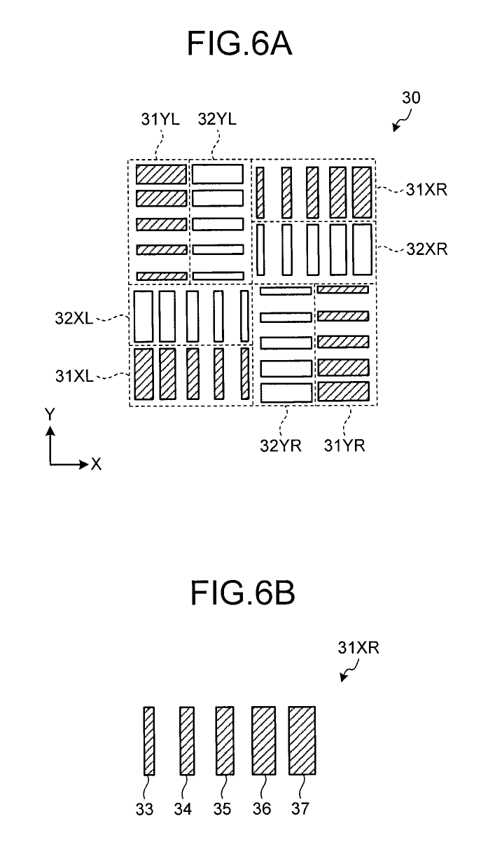

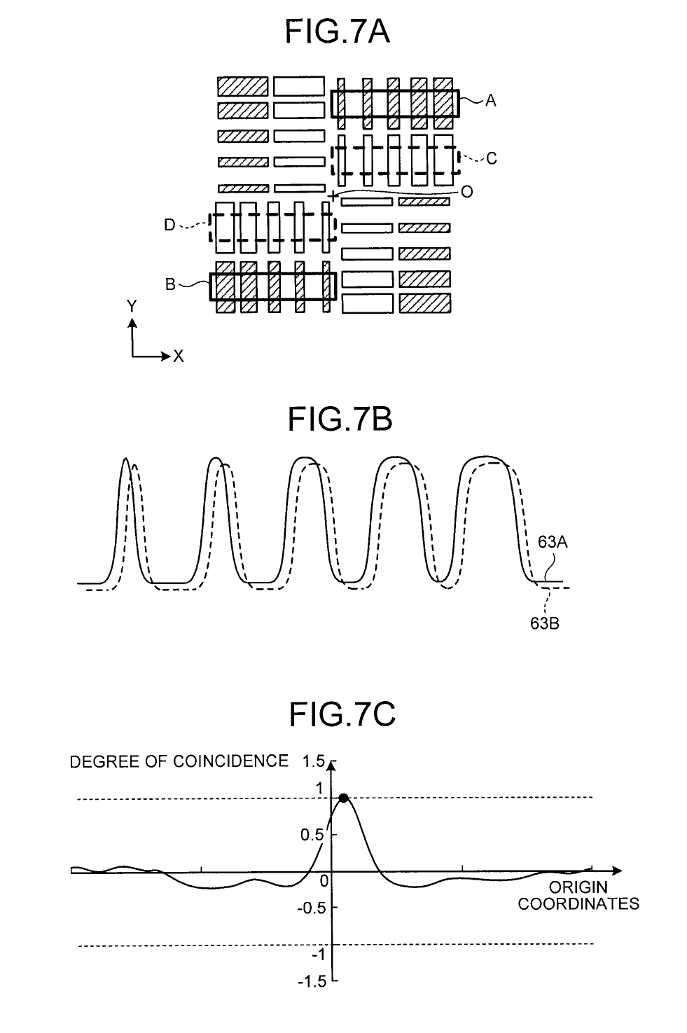

Next, the third embodiment of this invention will be explained with reference to FIG. 6A and FIG. 6B and FIG. 7A to FIG. 7C. In the third embodiment, the pitch of the line patterns forming the lower layer side marks 11 and the upper layer side marks 12 is made constant and the line pattern widths and the space widths each have two or more different dimensions.

FIG. 6A and FIG. 6B are diagrams illustrating a configuration of an overlay measurement mark according to the third embodiment. FIG. 6A illustrates a top view of an overlay measurement mark 30 according to the third embodiment. The overlay measurement mark 30 is an AIM mark or the like and is formed by using lower layer side patterns and upper layer side patterns. The lower layer side mark 11 and the upper layer side mark 12 are each a line and space type mark and are each formed such that the line pattern widths and the space widths have at least two or more different dimensions.

The overlay measurement mark 30 includes lower layer side marks 31XR, 31YR, 31XL, and 31YL as the lower layer side marks 11 and upper layer side marks 32XR, 32YR, 32XL, and 32YL as the upper layer side marks 12. In the following, the lower layer side marks 31XR, 31YR, 31XL, and 31YL are called the lower layer side marks 11 in some cases. Moreover, the upper layer side marks 32XR, 32YR, 32XL, and 32YL are called the upper layer side marks 12 in some cases.

The lower layer side marks 31XR and 31XL are line and space patterns formed by arranging a plurality of line patterns, which extend in the Y direction, in parallel in the X direction. Moreover, the lower layer side marks 31YR and 31YL are line and space patterns formed by arranging a plurality of line patterns, which extend in the X direction, in parallel in the Y direction.

The upper layer side marks 32XR and 32XL are line and space patterns formed by arranging a plurality of line patterns, which extend in the Y direction, in parallel in the X direction. Moreover, the upper layer side marks 32YR and 32YL are line and space patterns formed by arranging a plurality of line patterns, which extend in the X direction, in parallel in the Y direction.

The lower layer side marks 31XR, 31XL, 31YR, and 31YL and the upper layer side marks 32XR, 32XL, 32YR, and 32YL in the present embodiment are arranged at positions similar to the lower layer side marks 11XR, 11XL, 11YR, and 11YL and the upper layer side marks 12XR, 12XL, 12YR and 12YL in the first embodiment, respectively.

The configuration of the lower layer side marks 31XR, 31YR, 31XL, and 31YL and the upper layer side marks 32XR, 32YR, 32XL, and 32YL will be explained. The lower layer side marks 31XR, 31YR, 31XL, and 31YL and the upper layer side marks 32XR, 32YR, 32XL, and 32YL each have a similar configuration, therefore, the configuration of the lower layer side mark 31XR will be explained here.

FIG. 6B illustrates a top view of the lower layer side mark according to the third embodiment. The lower layer side mark 31XR includes five line patterns 33 to 37. The line pattern 33 is closest to origin coordinates O of the overlay measurement mark 30, the line pattern 34 is second closest to the origin coordinates O, and the line pattern 35 is third closest to the origin coordinates O. Moreover, the line pattern 36 is fourth closest to the origin coordinates O of the overlay measurement mark 30 and the line pattern 37 is farthest from the origin coordinates O. In other words, the line patterns 33 to 37 are arranged in the order of the line patterns 33, 34, 35, 36, and 37 in a direction away from the origin coordinates O of the overlay measurement mark 30.

The line patterns 33 to 37 are formed such that the pitch is made approximately constant and the line pattern widths and the space widths are each set to have a plurality of dimensions. For example, the line patterns 33 to 37 are arranged such that the line pattern width increases and the space width decreases as the distance from the origin coordinates O of the overlay measurement mark 30 increases.

In other words, the line pattern width decreases as the distance from the origin coordinates O decreases. Furthermore, the space width increases as the distance from the origin coordinates O decreases.

In a similar manner, each line pattern is arranged in the lower layer side marks 31YR, 31XL, and 31YL and the upper layer side marks 32XR, 32YR, 32XL, and 32YL in such a way that the line pattern width decreases and the space width increases as the distance from the origin coordinates O decreases.

Each line pattern may be arranged in the lower layer side marks 11 and the upper layer side marks 12 in such a way that the line pattern width increases and the space width decreases as the distance from the origin coordinates O decreases. Moreover, each line pattern may be arranged to have various space widths and various line pattern widths regardless of the distance from the origin coordinates O.

Next, the measuring method of the overlay displacement amount will be explained. The overlay displacement inspection apparatus 1 measures the overlay displacement amount between the lower layer side marks 11 and the upper layer side marks 12 by a processing procedure similar to the first embodiment.

Specifically, the overlay displacement inspection apparatus 1 calculates origin coordinates O1 of the lower layer side marks 31XR and 31XL and origin coordinates O2 of the upper layer side marks 32XR and 32XL to measure the overlay displacement amount in the X direction between the lower layer side marks 11 and the upper layer side marks 12. When calculating the origin coordinates O1 of the lower layer side marks 31XR and 31XL, measurement regions A and B are set in the lower layer side marks 31XR and 31XL.

Then, the signal analyzing unit 6 obtains waveforms representing the reflectance in the measurement regions A and B on the basis of an image in each of the measurement regions A and B. FIG. 7A to FIG. 7C are diagrams illustrating a waveform example representing the reflectance and the degree of coincidence with respect to the overlay measurement mark according to the third embodiment. FIG. 7A illustrates a ROI that is a measurement region of the overlay displacement amount and the origin coordinates O of the overlay measurement mark 30. In this embodiment, the measurement region A of the lower layer side mark 31XR, the measurement region B of the lower layer side mark 31XL, a measurement region C of the upper layer side mark 32XR, and a measurement region D of the upper layer side mark 32XL are illustrated as a ROI. FIG. 7B illustrates a waveform 63A representing the reflectance in the measurement region A and a waveform 63B representing the reflectance in the measurement region B.

The signal analyzing unit 6 derives the reflectance in the measurement region A for each position of the origin coordinates O and derives the reflectance in the measurement region B for each position of the origin coordinates O. In this way, the waveforms 63A and 63B representing the reflectance as shown in FIG. 7B are derived.

Furthermore, the signal analyzing unit 6 calculates the degree of coincidence between the waveform 63A representing the reflectance and the waveform 63B representing the reflectance for each position of the origin coordinates O. In this way, information on the degree of coincidence between the waveform 63A representing the reflectance and the waveform 63B representing the reflectance as shown in FIG. 7C is derived. In the graph in FIG. 7C, the horizontal axis indicates the origin coordinates O and the vertical axis indicates the degree of coincidence. The signal analyzing unit 6 uses the position of the origin coordinates O having the highest degree of coincidence among the degree of coincidence derived for each position of the origin coordinates O as the origin coordinates O1 of the lower layer side marks 31XR and 31XL.

Thereafter, the origin coordinates O2 of the upper layer side marks 32XR and 32XL is calculated by a processing procedure similar to the first embodiment. Then, the signal analyzing unit 6 compares the origin coordinates O1 of the lower layer side marks 31XR and 31XL with the origin coordinates O2 of the upper layer side marks 32XR and 32XL and sets the difference therebetween as the overlay displacement amount in the X direction.

The overlay displacement inspection apparatus 1 measures the overlay displacement amount in the Y direction between the lower layer side marks 11 and the upper layer side marks 12 by a processing procedure similar to the first embodiment, therefore, explanation thereof is omitted.

In the present embodiment, the line patterns 33 to 37 in the lower layer side marks 31XR, 31XL, 31YR, and 31YL and the upper layer side marks 32XR, 32XL, 32YR, and 32YL are formed with two or more line pattern widths and two or more space widths. For example, in the case of the lower layer side mark 31XR shown in FIG. 6A, the lower layer side mark 31XR is composed of the line pattern 33 having a first line pattern width, the line pattern 34 having a second line pattern width, the line pattern 35 having a third line pattern width, the line pattern 36 having a fourth line pattern width, and the line pattern 37 having a fifth line pattern width. Moreover, the space of the lower layer side mark 31XR is formed with a first space width between the line patterns 33 and 34, a second space width between the line patterns 34 and 35, a third space width between the line patterns 35 and 36, and a fourth space width between the line patterns 36 and 37.

Therefore, in a similar manner to the first embodiment, it is prevented that a position displaced by 1 pitch, ½ pitch, or ¼ pitch in a line and space is determined as the origin coordinates O of the lower layer side marks 31XR and 31XL.

This is because the line patterns 33 to 37 are arranged with various line pattern widths and various line pattern intervals (space widths) and therefore only one peak of the degree of coincidence appears at the position (position of the correct origin coordinates O) with no pitch displacement when the overlay displacement amount is measured by using the line patterns 33 to 37.

In this manner, in the present embodiment, because the lower layer side marks 11 and the upper layer side marks 12 are formed with the same pitch and with various line pattern widths and space widths, erroneous measurement (measurement jump), which may occur depending on the quality of the overlay measurement mark 30 and the periphery of the overlay measurement mark 30, can be prevented. Moreover, an unexpectedly large overlay displacement can be detected.

The arrangement of the lower layer side marks 11 and the upper layer side marks 12 of the overlay measurement mark 30 is not limited to that shown in FIG. 6A and FIG. 6B. Moreover, the number of the line patterns of the lower layer side mark 11 (for example, the lower layer side mark 31XR) and the upper layer side mark 12 is not limited to five as long as it is three or more.

In this manner, according to the third embodiment, because the pitch of the line patterns forming the lower layer side marks 11 and the upper layer side marks 12 is made constant and the line pattern widths and the space widths each have two or more different dimensions, erroneous measurement of the overlay displacement amount can be reduced.

### Fourth Embodiment

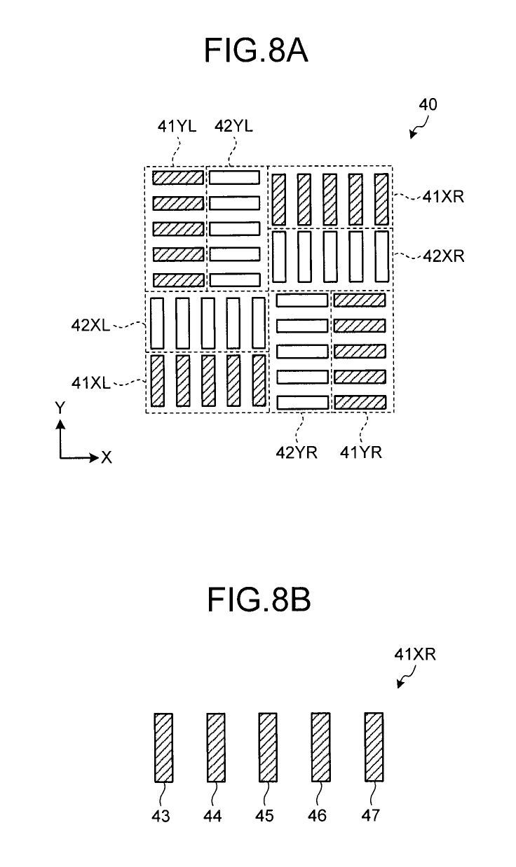

Next, the fourth embodiment of this invention will be explained with reference to FIG. 8A to FIG. 10C. In the fourth embodiment, various pattern density distributions or pattern densities are applied to each of the line pattern regions (positions at which the line patterns 13 to 17 are arranged) forming the lower layer side marks 11 and the upper layer side marks 12. In other words, a pattern group having a different pattern density distribution or pattern density is arranged in each line pattern region.

FIG. 8A and FIG. 8B are diagrams illustrating a configuration of an overlay measurement mark according to the fourth embodiment. FIG. 8A illustrates a top view of an overlay measurement mark 40 according to the fourth embodiment. The overlay measurement mark 40 is an AIM mark or the like and is formed by using lower layer side patterns and upper layer side patterns. The lower layer side marks 11 and the upper layer side marks 12 are each a line and space type mark.

The overlay measurement mark 40 includes lower layer side marks 41XR, 41YR, 41XL, and 41YL as the lower layer side marks 11 and upper layer side marks 42XR, 42YR, 42XL, and 42YL as the upper layer side marks 12. In the following, the lower layer side marks 41XR, 41YR, 41XL, and 41YL are called the lower layer side marks 11 in some cases. Moreover, the upper layer side marks 42XR, 42YR, 42XL, and 42YL are called the upper layer side marks 12 in some cases.

The lower layer side marks 41XR and 41XL are line and space patterns formed by arranging a plurality of line pattern regions, which extend in the Y direction, in parallel in the X direction. Moreover, the lower layer side marks 41YR and 41YL are line and space patterns formed by arranging a plurality of line pattern regions, which extend in the X direction, in parallel in the Y direction.

The upper layer side marks 42XR and 42XL are line and space patterns formed by arranging a plurality of line pattern regions, which extend in the Y direction, in parallel in the X direction. Moreover, the upper layer side marks 42YR and 42YL are line and space patterns formed by arranging a plurality of line pattern regions, which extend in the X direction, in parallel in the Y direction.

The lower layer side marks 41XR, 41XL, 41YR and 41YL and the upper layer side marks 42XR, 42XL, 42YR, and 42YL in the present embodiment are arranged at positions similar to the lower layer side marks 11XR, 11XL, 11YR, and 11YL and the upper layer side marks 12XR, 12XL, 12YR, and 12YL in the first embodiment, respectively.

The configuration of the lower layer side marks 41XR, 41YR, 41XL, and 41YL and the upper layer side marks 42XR, 42YR, 42XL, and 42YL will be explained. The lower layer side marks 41XR, 41YR, 41XL, and 41YL and the upper layer side marks 42XR, 42YR, 42XL, and 42YL each have a similar configuration, therefore, the configuration of the lower layer side mark 41XR will be explained here.

FIG. 8B illustrates a top view of the lower layer side mark according to the fourth embodiment. The lower layer side mark 41XR includes five line pattern regions 43 to 47. The line pattern region 43 is closest to origin coordinates O of the overlay measurement mark 40, the line pattern region 44 is second closest to the origin coordinates O, and the line pattern region 45 is third closest to the origin coordinates O. Moreover, the line pattern region 46 is fourth closest to the origin coordinates O of the overlay measurement mark 40 and the line pattern region 47 is farthest from the origin coordinates O. In other words, the line pattern regions 43 to 47 are arranged in the order of the line pattern regions 43, 44, 45, 46, and 47 in a direction away from the origin coordinates O of the overlay measurement mark 40.

The line pattern regions 43 to 47 are such that the line-pattern-region widths (lateral direction) are approximately the same dimension and the space-pattern-region widths between the line pattern regions are approximately the same dimension. For example, the line pattern regions 43 to 47 have the same shape and size.

In the line pattern regions 43 to 47, a plurality of line patterns is arranged to have various pattern density distributions or various pattern densities in the X direction. In this manner, the lower layer side mark 41XR is segmented into five line pattern regions 43 to 47 and the pattern density distribution or the pattern density is varied in each segment.

In a similar manner, in the lower layer side marks 41YR, 41XL, and 41YL, and the upper layer side marks 42XR, 42YR, 42XL, and 42YL, the line pattern regions are arranged such that the line-pattern-region widths (lateral direction) are approximately the same dimension and the widths between the line pattern regions are approximately the same dimension.

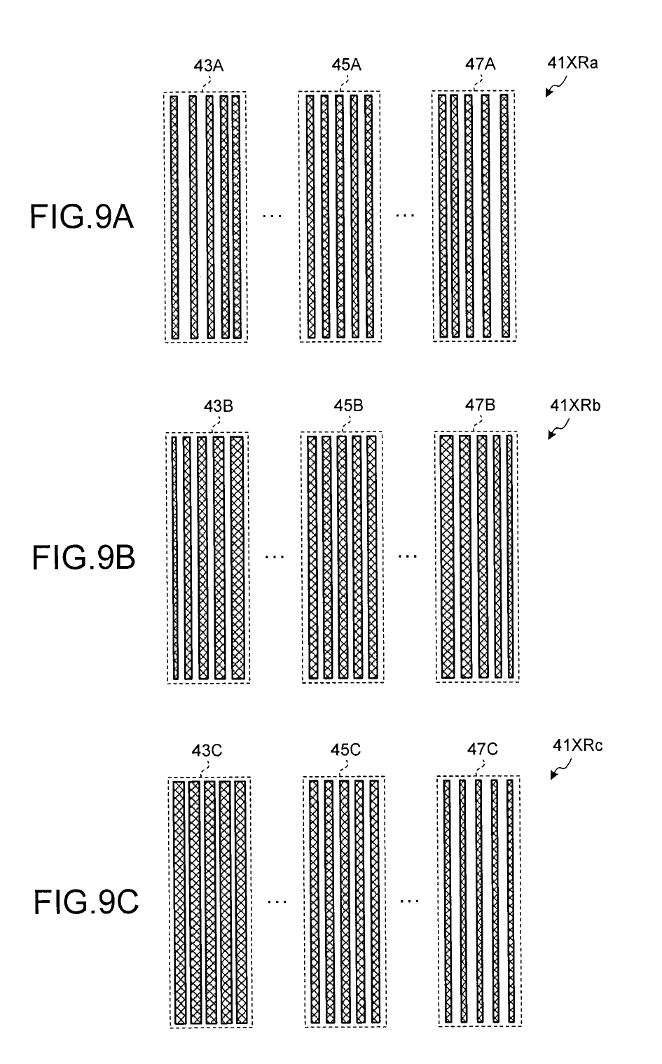

Next, the configuration of line patterns arranged in each of the line pattern regions 43 to 47 will be explained. FIG. 9A to FIG. 9C are diagrams illustrating a configuration of line patterns arranged in the line pattern regions. FIG. 9A to FIG. 9C illustrate top views in each of the line pattern regions 43 to 47.

FIG. 9A illustrates a configuration of a lower layer side mark 41XRa as an example of the lower layer side mark 41XR. In the lower layer side mark 41XRa, line patterns are arranged in line pattern regions 43A to 47A as the line pattern regions 43 to 47. In FIG. 9A, the line pattern regions 44A and 46A are not illustrated. The line patterns in the line pattern regions 43A to 47A each have approximately the same line pattern width.

In the line pattern region 43A, a plurality of line patterns is arranged such that the left end portion side (side opposite to the line pattern region 44A) has a lower pattern density than the right end portion side (line pattern region 44 side).

Moreover, in the line pattern region 44A, a plurality of line patterns is arranged such that the left end portion side (line pattern region 43A side) has a lower pattern density than the right end portion side (line pattern region 45A side).

In this case, the line patterns are arranged such that the left end portion side of the line pattern region 43A has a lower pattern density than the left end portion side of the line pattern region 44A. The line patterns may be arranged such that the right end portion side of the line pattern region 43A has a higher pattern density than the right end portion side of the line pattern region 44A.

In other words, the line patterns are arranged in the line pattern regions 43A and 44A in such a way that the difference in the pattern density between the left end portion side and the right end portion side becomes larger in the line pattern region 43A than the line pattern region 44A.

Moreover, in the line pattern region 47A, a plurality of line patterns is arranged such that the right end portion side (side opposite to the line pattern region 46A) has a lower pattern density than the left end portion side (line pattern region 46A side).

Moreover, in the line pattern region 46A, a plurality of line patterns is arranged such that the right end portion side (line pattern region 47A side) has a lower pattern density than the left end portion side (line pattern region 45A side).

In this case, the line patterns are arranged such that the right end portion side of the line pattern region 47A has a lower pattern density than the right end portion side of the line pattern region 46A. The line patterns may be arranged such that the left end portion side of the line pattern region 47A has a higher pattern density than the left end portion side of the line pattern region 46A.

In other words, the line patterns are arranged in the line pattern regions 46A and 47A in such a way that the difference in the pattern density between the left end portion side and the right end portion side becomes larger in the line pattern region 47A than the line pattern region 46A.

Moreover, in the line pattern region 45A, a plurality of line patterns is arranged such that the pattern density becomes approximately constant in the line pattern region 45A.

For example, in the line pattern regions 43A and 44A, a plurality of line patterns is arranged such that the line pattern width is constant and the space width gradually decreases from the left end portion side to the right end portion side. Moreover, in the line pattern regions 46A and 47A, a plurality of line patterns is arranged such that the line pattern width is constant and the space width gradually decreases from the right end portion side to the left end portion side.

Moreover, in the line pattern region 45A, a plurality of line patterns is arranged such that the line pattern widths (lateral direction) are approximately the same dimension and the space widths between the line patterns are approximately the same dimension. For example, in the line pattern region 45A, a plurality of line patterns having the same shape and size is arranged.

FIG. 9B illustrates a configuration of a lower layer side mark 41XRb as another example of the lower layer side mark 41XR. In the lower layer side mark 41XRb, line patterns are arranged in line pattern regions 43B to 47B as the line pattern regions 43 to 47. In FIG. 9B, the line pattern regions 44B and 46B are not illustrated. The space widths between the line patterns in each of the line pattern regions 43B to 47B are approximately the same.

The line pattern regions 43B to 47B each have a pattern density distribution (non-uniform pattern density) in a similar manner to the line pattern regions 43A to 47A. Specifically, in the line pattern region 43B, a plurality of line patterns is arranged such that the left end portion side (side opposite to the line pattern region 44B) has a lower pattern density than the right end portion side (line pattern region 44B side).

Moreover, in the line pattern region 44B, a plurality of line patterns is arranged such that the left end portion side (line pattern region 43B side) has a lower pattern density than the right end portion side (line pattern region 45B side).

In this case, the line patterns are arranged such that the left end portion side of the line pattern region 43B has a lower pattern density than the left end portion side of the line pattern region 44B. The line patterns may be arranged such that the right end portion side of the line pattern region 43B has a higher pattern density than the right end portion side of the line pattern region 44B.

In other words, the line patterns are arranged in the line pattern regions 43B and 44B in such a way that the difference in the pattern density between the left end portion side and the right end portion side becomes larger in the line pattern region 43B than the line pattern region 44B.

Moreover, in the line pattern region 47B, a plurality of line patterns is arranged such that the right end portion side (side opposite to the line pattern region 46B) has a lower pattern density than the left end portion side (line pattern region 46B side).

Moreover, in the line pattern region 46B, a plurality of line patterns is arranged such that the right end portion side (line pattern region 47B side) has a lower pattern density than the left end portion side (line pattern region 45B side).

In this case, the line patterns are arranged such that the right end portion side of the line pattern region 47B has a lower pattern density than the right end portion side of the line pattern region 46B. The line patterns may be arranged such that the left end portion side of the line pattern region 47B has a higher pattern density than the left end portion side of the line pattern region 46B.

In other words, the line patterns are arranged in the line pattern regions 46B and 47B in such a way that the difference in the pattern density between the left end portion side and the right end portion side becomes larger in the line pattern region 47B than the line pattern region 46B.

Moreover, in the line pattern region 45B, a plurality of line patterns is arranged such that the pattern density becomes approximately constant in the line pattern region 45B.

For example, in the line pattern regions 43B and 44B, a plurality of line patterns is arranged such that the space width is constant and the line pattern width gradually increases from the left end portion side to the right end portion side. Moreover, in the line pattern regions 46B and 47B, a plurality of line patterns is arranged such that the space width is constant and the line pattern width gradually increases from the right end portion side to the left end portion side.

Moreover, in the line pattern region 45B, a plurality of line patterns is arranged such that the line pattern widths (lateral direction) are approximately the same dimension and the space widths between the line patterns are approximately the same dimension. For example, in the line pattern region 45B, a plurality of line patterns having the same shape and size is arranged.

FIG. 9C illustrates a configuration of a lower layer side mark 41XRc as still another example of the lower layer side mark 41XR. In the lower layer side mark 41XRc, line patterns are arranged in line pattern regions 43C to 47C as the line pattern regions 43 to 47. In FIG. 9C, the line pattern regions 44C and 46C are not illustrated.

The line pattern regions 43C to 47C each have a different pattern density. Specifically, in each of the line pattern regions 43C to 47C, a plurality of line patterns is arranged such that the pattern density decreases in the order of the line pattern regions 43C, 44C, 45C, 46C, and 47C.

For example, in each of the line pattern regions 43C to 47C, a plurality of line patterns is arranged such that the line pattern width decreases and the space width increases in the order of the line pattern regions 43C, 44C, 45C, 46C, and 47C. In each of the line pattern regions 43C to 47C, a plurality of line patterns having the same line pattern width may be arranged such that the space width increases in the order of the line pattern regions 43C, 44C, 45C, 46C, and 47C. Moreover, in each of the line pattern regions 43C to 47C, a plurality of line patterns having the same space width may be arranged such that the line pattern width decreases in the order of the line pattern regions 43C, 44C, 45C, 46C, and 47C. Moreover, each line pattern may be arranged to have various space widths and line pattern widths regardless of the distance from the origin coordinates O.

In the present embodiment, a case in which the lower layer side mark 41XRa has five pattern density distributions (five line pattern regions 43A to 47A) is explained, however, it is sufficient that the lower layer side mark 41XRa has two or more pattern density distributions (two or more line pattern regions).

Moreover, in the present embodiment, a case in which the lower layer side mark 41XRb has five pattern density distributions (five line pattern regions 43B to 47B) is explained, however, it is sufficient that the lower layer side mark 41XRb has two or more pattern density distributions (two or more line pattern regions).

Moreover, in the present embodiment, a case in which the lower layer side mark 41XRc has five pattern densities (five line pattern regions 43C to 47C) is explained, however, it is sufficient that the lower layer side mark 41XRc has two or more pattern densities (two or more line pattern regions).

The overlay displacement inspection apparatus 1 measures the overlay displacement amount between the lower layer side marks 11 and the upper layer side marks 12 by a processing procedure similar to the first embodiment. Specifically, the overlay displacement inspection apparatus 1 calculates origin coordinates O1 of the lower layer side marks 41XR and 41XL and origin coordinates O2 of the upper layer side marks 42XR and 42XL to measure the overlay displacement amount in the X direction between the lower layer side marks 11 and the upper layer side marks 12. When calculating the origin coordinates O1 of the lower layer side marks 41XR and 41XL, measurement regions A and B are set in the lower layer side marks 41XR and 41XL.

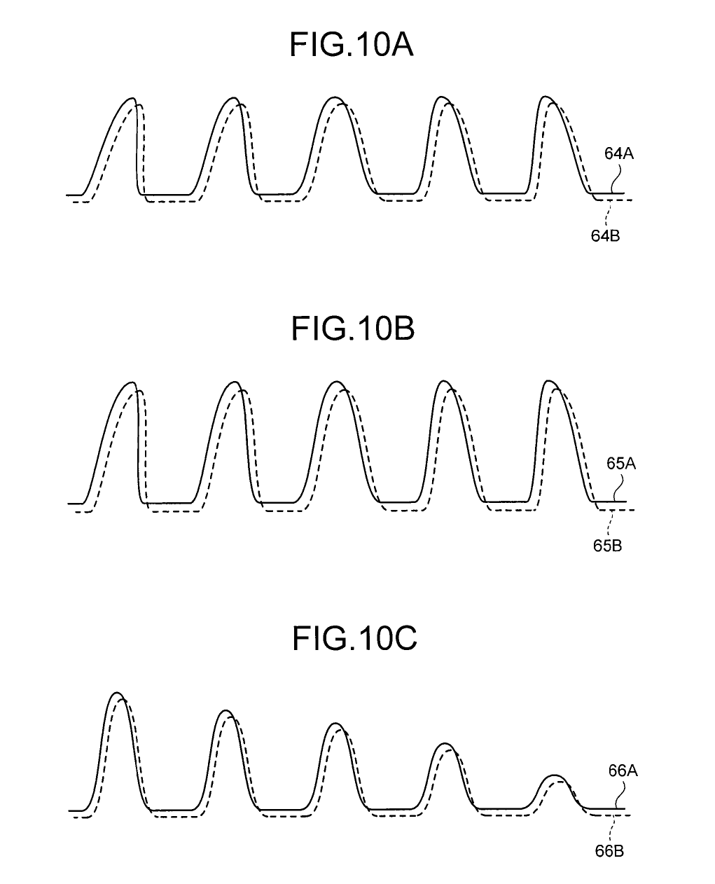

Then, the signal analyzing unit 6 obtains waveforms representing the reflectance in the measurement regions A and B on the basis of an image in each of the measurement regions A and B. FIG. 10A to FIG. 10C are diagrams illustrating waveform examples representing the reflectance with respect to the overlay measurement mark according to the fourth embodiment. FIG. 10A illustrates a waveform 64A representing the reflectance in the measurement region A with respect to the lower layer side mark 41XR and a waveform 64B representing the reflectance in the measurement region B with respect to the lower layer side mark 41XL when a pattern group in each line pattern region is arranged as shown in FIG. 9A. FIG. 10B illustrates a waveform 65A representing the reflectance in the measurement region A with respect to the lower layer side mark 41XR and a waveform 65B representing the reflectance in the measurement region B with respect to the lower layer side mark 41XL when a pattern group in each line pattern region is arranged as shown in FIG. 9B. FIG. 10C illustrates a waveform 66A representing the reflectance in the measurement region A with respect to the lower layer side mark 41XR and a waveform 66B representing the reflectance in the measurement region B with respect to the lower layer side mark 41XL when a pattern group in each line pattern region is arranged as shown in FIG. 9C.

The signal analyzing unit 6 derives the reflectance in the measurement region A for each position of the origin coordinates O and derives the reflectance in the measurement region B for each position of the origin coordinates O. In this manner, in the case of the pattern arrangement shown in FIG. 9A, the waveforms 64A and 64B representing the reflectance as shown in FIG. 10A are derived. Specifically, the waveforms 64A and 64B, in which each peak portion is asymmetric, are derived.

Moreover, in the case of the pattern arrangement shown in FIG. 9B, the waveforms 65A and 65B representing the reflectance as shown in FIG. 10B are derived. Specifically, the waveforms 65A and 65B, in which each peak portion is asymmetric, are derived.

Moreover, in the case of the pattern arrangement shown in FIG. 9C, the waveforms 66A and 66B representing the reflectance as shown in FIG. 10C are derived. Specifically, the waveforms 66A and 66B, in which each peak portion has a different height, are derived. Thereafter, the overlay displacement amount in the X direction and the overlay displacement amount in the Y direction are calculated by the processing similar to the first embodiment.

In this manner, in the present embodiment, line patterns are arranged in a plurality of line pattern regions with various pattern density distributions or various pattern densities. For example, in the case of the lower layer side mark 41XRa shown in FIG. 9A, the lower layer side mark 41XRa is composed of the line pattern region 43A having a first pattern density distribution, the line pattern region 44A having a second pattern density distribution, the line pattern region 45A having a third pattern density distribution, the line pattern region 46A having a fourth pattern density distribution, and the line pattern region 47A having a fifth pattern density distribution. In a similar manner, in the case of the lower layer side mark 41XRb shown in FIG. 9B, the line pattern regions of the lower layer side mark 41XRb have a plurality of pattern density distributions. Therefore, each line pattern region of the lower layer side mark 41XRb has film unevenness. Moreover, line patterns are arranged in a plurality of line pattern regions with various pattern densities as in the lower layer side mark 41XRc shown in FIG. 9C.

Therefore, in a similar manner to the first embodiment, it is prevented that a position displaced by 1 pitch, ½ pitch, or ¼ pitch in a line and space is determined as the origin coordinates O of the lower layer side marks 41XR and 41XL.

This is because the line pattern regions 43 to 47 are formed with various pattern density distributions or various pattern densities and therefore gradation is created when macro observation is performed. When the overlay displacement amount is measured by using the line pattern regions 43 to 47, only one peak of the degree of coincidence appears at the position (position of the correct origin coordinates O) with no pitch displacement.

In this manner, in the present embodiment, because the lower layer side mark 41XRa and the lower layer side mark 41XRb are formed with various pattern density distributions, it is possible to obtain a waveform representing the reflectance having asymmetric peak portions. In other words, it is possible to obtain a mark contrast different for each line pattern region. Moreover, because the lower layer side mark 41XRc is formed with various pattern densities, it is possible to obtain a waveform having peak portions of different heights for each line pattern region. The lower layer side marks 41YR, 41XL, and 41YL and the upper layer side marks 42XR, 42YR, 42XL, and 42YL have a configuration similar to the lower layer side mark 41XR.

Therefore, erroneous measurement (measurement jump), which may occur depending on the quality of the overlay measurement mark 40 and the periphery of the overlay measurement mark 40, can be prevented. Moreover, an unexpectedly large overlay displacement can be detected.

Moreover, in the present embodiment, a case in which line patterns are arranged in the line pattern regions 43 to 47 is explained, however, patterns having a shape other than a line pattern may be arranged in the line pattern regions 43 to 47. For example, contact hole patterns or the like may be arranged in the line pattern regions 43 to 47.

The arrangement of the lower layer side marks 11 and the upper layer side marks 12 of the overlay measurement mark 40 is not limited to that shown in FIG. 8A and FIG. 8B. Moreover, the number of line pattern regions of the lower layer side mark 11 (for example, the lower layer side mark 41XR) and the upper layer side mark 12 is not limited to five as long as it is two or more.

In this manner, according to the fourth embodiment, because various pattern density distributions or pattern densities are applied to each of the line pattern regions forming the lower layer side marks 11 and the upper layer side marks 12, erroneous measurement of the overlay displacement amount can be reduced.

### Fifth Embodiment

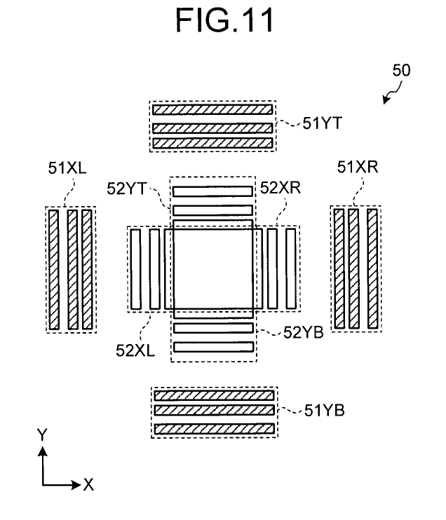

Next, the fifth embodiment of this invention will be explained with reference to FIG. 11. In the fifth embodiment, the line patterns explained in the first to fourth embodiments are arranged in a bar-in-bar type overlay measurement mark.

FIG. 11 is a diagram illustrating a configuration of an overlay measurement mark according to the fifth embodiment. FIG. 11 illustrates a top view of an overlay measurement mark 50 according to the first embodiment. The overlay measurement mark 50 is a bar-in-bar type mark and is formed by using lower layer side patterns and upper layer side patterns. The lower layer side marks 11 and the upper layer side marks 12 are each line and space type marks arranged on four sides of the origin coordinates O of the overlay measurement mark 50 to surround the origin coordinates O.

The overlay measurement mark 50 includes lower layer side marks 51XR, 51YB, 51XL, and 51YT as the lower layer side marks 11 and upper layer side marks 52XR, 52YB, 52XL, and 52YT as the upper layer side marks 12. In the following, the lower layer side marks 51XR, 51YB, 51XL, and 51YT are called the lower layer side marks 11 in some cases. Moreover, the upper layer side marks 52XR, 52YB, 52XL, and 52YT are called the upper layer side marks 12 in some cases.

The lower layer side marks 51XR and 51XL are line and space patterns formed by arranging a plurality of line patterns, which extend in the Y direction, in parallel in the X direction. Moreover, the lower layer side marks 51YB and 51YT are line and space patterns formed by arranging a plurality of line patterns, which extend in the X direction, in parallel in the Y direction.

The upper layer side marks 52XR and 52XL are line and space patterns formed by arranging a plurality of line patterns, which extend in the Y direction, in parallel in the X direction. Moreover, the upper layer side marks 52YB and 52YT are line and space patterns formed by arranging a plurality of line patterns, which extend in the X direction, in parallel in the Y direction.

The lower layer side mark 51XR and the lower layer side mark 51XL have point-symmetry about the center of the lower layer side marks 11 being a symmetry center. In a similar manner, the lower layer side mark 51YB and the lower layer side mark 51YT have point-symmetry about the center of the lower layer side marks 11 being a symmetry center.

Moreover, the upper layer side mark 52XR and the upper layer side mark 52XL have point-symmetry about the center of the upper layer side marks 12 being a symmetry center. In a similar manner, the upper layer side mark 52YB and the upper layer side mark 52YT have point-symmetry about the center of the upper layer side marks 12 being a symmetry center.

The configuration of the lower layer side marks 51XR, 51YB, 51XL, and 51YT and the upper layer side marks 52XR, 52YB, 52XL, and 52YT will be explained. The lower layer side marks 51XR, 51YB, 51XL, and 51YT and the upper layer side marks 52XR, 52YB, 52XL, and 52YT each have a similar configuration, therefore, the configuration of the lower layer side mark 51XR will be explained here.

The lower layer side mark 51XR, for example, has a configuration similar to the lower layer side mark 11XR explained in the first embodiment. In this case, the lower layer side mark 51XR includes three or more line patterns. Each line pattern is a line pattern having a line pattern width (lateral direction) of approximately the same dimension and the space widths between the line patterns are set to have a plurality of dimensions.

The lower layer side mark 51XR may have a configuration similar to the lower layer side mark 21XR explained in the second embodiment. In this case, the lower layer side mark 51XR includes two or more line patterns. Each line pattern of the lower layer side mark 51XR is a line pattern arranged such that the space widths between the line patterns are approximately the same dimension and the line pattern widths are set to have a plurality of dimensions.

Moreover, the lower layer side mark 51XR may have a configuration similar to the lower layer side mark 31XR explained in the third embodiment. In this case, the lower layer side mark 51XR includes three or more line patterns. Each line pattern of the lower layer side mark 51XR is a line pattern formed such that the pitch is made approximately constant and the line pattern widths and the space widths are each set to have a plurality of dimensions.

Moreover, the lower layer side mark 51XR may have a configuration similar to the lower layer side mark 41XR explained in the fourth embodiment. In this case, the lower layer side mark 51XR includes two or more line pattern regions. In each line pattern region of the lower layer side mark 51XR, line patterns are arranged to have various pattern density distributions or pattern densities.

In this manner, in the present embodiment, the lower layer side mark 51XR has a configuration similar to the lower layer side marks 11XR, 21XR, 31XR, or 41XR explained in the first to fourth embodiments. The lower layer side marks 51YB, 51XL, and 51YT and the upper layer side marks 52XR, 52YB, 52XL, and 52YT each have a configuration similar to the lower layer side mark 51XR.

Therefore, according to the fifth embodiment, because the lower layer side marks 51XR, 51YB, 51XL, and 51YT and the upper layer side marks 52XR, 52YB, 52XL, and 52YT have a configuration similar to the lower layer side marks 11 and the upper layer side marks 12 explained in the first to fourth embodiments, erroneous measurement of the overlay displacement amount can be reduced. In the present embodiment, the line patterns explained in the first to fourth embodiments may be arranged in a box-in-box type overlay measurement mark.

As described above, according to the first to fifth embodiments, overlay measurement with reduced erroneous measurement can be performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An overlay measuring method comprising:
irradiating a first overlay measurement mark formed by using a first layer so that each line pattern of a first line pattern group extends in a direction parallel to a first direction in a substrate surface, and a second overlay measurement mark that is formed by using the first layer and has point-symmetry with the first overlay measurement mark, with illumination light and receiving reflected light from the first and second overlay measurement marks, and irradiating a third overlay measurement mark formed by using a second layer so that each line pattern of a second line pattern group extends in a direction parallel to the first direction in the substrate surface, and a fourth overlay measurement mark that is formed by using the second layer and has point-symmetry with the third overlay measurement mark, with illumination light and receiving reflected light from the third and fourth overlay measurement marks;
calculating a first symmetry center coordinate with respect to the first and second overlay measurement marks in a second direction vertical to the first direction in the substrate surface on a basis of an intensity profile of reflected light from each line pattern in the first and second overlay measurement marks, and calculating a second symmetry center coordinate with respect to the third and fourth overlay measurement marks in the second direction in the substrate surface on a basis of an intensity profile of reflected light from each line pattern in the third and fourth overlay measurement marks; and
calculating an overlay displacement amount in the second direction between a pattern formed by using the first layer and a pattern formed by using the second layer on a basis of the first symmetry center coordinate and the second symmetry center coordinate, wherein
the first to fourth overlay measurement marks have a plurality of space widths or a plurality of pattern widths in the second direction.

2. The overlay measuring method according to claim 1, further comprising:
irradiating a fifth overlay measurement mark formed by using the first layer so that each line pattern of a third line pattern group extends in a direction parallel to the second direction in the substrate surface, and a sixth overlay measurement mark that is formed by using the first layer and has point-symmetry with the fifth overlay measurement mark, with illumination light and receiving reflected light from the fifth and sixth overlay measurement marks, and irradiating a seventh overlay measurement mark formed by using the second layer so that each line pattern of a fourth line pattern group extends in a direction parallel to the second direction in the substrate surface, and an eighth overlay measurement mark that is formed by using the second layer and has point-symmetry with the seventh overlay measurement mark, with illumination light and receiving reflected light from the seventh and eighth overlay measurement marks;
calculating a third symmetry center coordinate with respect to the fifth and sixth overlay measurement marks in the first direction in the substrate surface on a basis of an intensity profile of reflected light from each line pattern in the fifth and sixth overlay measurement marks, and calculating a fourth symmetry center coordinate with respect to the seventh and eighth overlay measurement marks in the first direction in the substrate surface on a basis of an intensity profile of reflected light from each line pattern in the seventh and eighth overlay measurement marks; and
calculating an overlay displacement amount in the first direction between a pattern formed by using the first layer and a pattern formed by using the second layer on a basis of the third symmetry center coordinate and the fourth symmetry center coordinate, wherein
the fifth to eighth overlay measurement marks have a plurality of space widths or a plurality of pattern widths in the first direction.

3. The overlay measuring method according to claim 1, wherein
each of the first to fourth overlay measurement marks includes three or more line patterns having approximately the same pattern width in the second direction, and
the line patterns are arranged to have a plurality of space widths in the second direction.

4. The overlay measuring method according to claim 1, wherein
each of the first to fourth overlay measurement marks includes two or more line patterns having different pattern widths in the second direction, and
the line patterns are arranged to have approximately the same space width in the second direction.

5. The overlay measuring method according to claim 1, wherein each of the first to fourth overlay measurement marks includes two or more line patterns having approximately the same pattern pitch in the second direction and different pattern widths in the second direction.

6. The overlay measuring method according to claim 2, wherein the first to eighth overlay measurement marks are a line and space type mark.

7. The overlay measuring method according to claim 2, wherein the first to eighth overlay measurement marks are a bar-in-bar type mark.

8. An overlay measuring method comprising:
irradiating a first overlay measurement mark formed by using a first layer so that each line pattern region of a first line pattern region group extends in a direction parallel to a first direction with a first space pattern region therebetween in a substrate surface, and a second overlay measurement mark that is formed by using the first layer and has point-symmetry with the first overlay measurement mark, with illumination light and receiving reflected light from the first and second overlay measurement marks, and irradiating a third overlay measurement mark formed by using a second layer so that each line pattern region of a second line pattern region group extends in a direction parallel to the first direction with a second space pattern region therebetween in the substrate surface, and a fourth overlay measurement mark that is formed by using the second layer and has point-symmetry with the third overlay measurement mark, with illumination light and receiving reflected light from the third and fourth overlay measurement marks;
calculating a first symmetry center coordinate with respect to the first and second overlay measurement marks in a second direction vertical to the first direction in the substrate surface on a basis of an intensity profile of reflected light from the first and second overlay measurement marks, and calculating a second symmetry center coordinate with respect to the third and fourth overlay measurement marks in the second direction in the substrate surface on a basis of an intensity profile of reflected light from the third and fourth overlay measurement marks; and
calculating an overlay displacement amount in the second direction between a pattern formed by using the first layer and a pattern formed by using the second layer on a basis of the first symmetry center coordinate and the second symmetry center coordinate, wherein
each line pattern region of the first line pattern region group has a different pattern density distribution in the second direction for each line pattern region, and
each line pattern region of the second line pattern region group has a different pattern density distribution in the second direction for each line pattern region.

9. The overlay measuring method according to claim 8, further comprising:
irradiating a fifth overlay measurement mark formed by using the first layer so that each line pattern region of a third line pattern region group extends in a direction parallel to the second direction with a third space pattern region therebetween in the substrate surface, and a sixth overlay measurement mark that is formed by using the first layer and has point-symmetry with the fifth overlay measurement mark, with illumination light and receiving reflected light from the fifth and sixth overlay measurement marks, and irradiating a seventh overlay measurement mark formed by using the second layer so that each line pattern region of a fourth line pattern region group extends in a direction parallel to the second direction with a fourth space pattern region therebetween in the substrate surface, and an eighth overlay measurement mark that is formed by using the second layer and has point-symmetry with the seventh overlay measurement mark, with illumination light and receiving reflected light from the seventh and eighth overlay measurement marks;
calculating a third symmetry center coordinate with respect to the fifth and sixth overlay measurement marks in the first direction in the substrate surface on a basis of an intensity profile of reflected light from the fifth and sixth overlay measurement marks, and calculating a fourth symmetry center coordinate with respect to the seventh and eighth overlay measurement marks in the first direction in the substrate surface on a basis of an intensity profile of reflected light from the seventh and eighth overlay measurement marks; and
calculating an overlay displacement amount in the first direction between a pattern formed by using the first layer and a pattern formed by using the second layer on a basis of the third symmetry center coordinate and the fourth symmetry center coordinate, wherein
each line pattern region of the third line pattern region group has a different pattern density distribution in the first direction for each line pattern region, and
each line pattern region of the fourth line pattern region group has a different pattern density distribution in the first direction for each line pattern region.

10. The overlay measuring method according to claim 8, wherein, in at least part of line pattern regions in each of the first and second line pattern region groups, a plurality of line patterns is arranged to have a plurality of space widths or a plurality of pattern widths in the second direction.

11. The overlay measuring method according to claim 10, wherein the line patterns are arranged to have a plurality of space widths in the second direction.

12. The overlay measuring method according to claim 10, wherein the line patterns are arranged to have a plurality of pattern widths in the second direction.

13. The overlay measuring method according to claim 9, wherein the first to eighth overlay measurement marks are a line and space type mark.

14. The overlay measuring method according to claim 9, wherein the first to eighth overlay measurement marks are a bar-in-bar type mark.

15. An overlay measuring method comprising:
irradiating a first overlay measurement mark formed by using a first layer so that each line pattern region of a first line pattern region group extends in a direction parallel to a first direction with a first space pattern region therebetween in a substrate surface, and a second overlay measurement mark that is formed by using the first layer and has point-symmetry with the first overlay measurement mark, with illumination light and receiving reflected light from the first and second overlay measurement marks, and irradiating a third overlay measurement mark formed by using a second layer so that each line pattern region of a second line pattern region group extends in a direction parallel to the first direction with a second space pattern region therebetween in the substrate surface, and a fourth overlay measurement mark that is formed by using the second layer and has point-symmetry with the third overlay measurement mark, with illumination light and receiving reflected light from the third and fourth overlay measurement marks;
calculating a first symmetry center coordinate with respect to the first and second overlay measurement marks in a second direction vertical to the first direction in the substrate surface on a basis of an intensity profile of reflected light from the first and second overlay measurement marks, and calculating a second symmetry center coordinate with respect to the third and fourth overlay measurement marks in the second direction in the substrate surface on a basis of an intensity profile of reflected light from the third and fourth overlay measurement marks; and
calculating an overlay displacement amount in the second direction between a pattern formed by using the first layer and a pattern formed by using the second layer on a basis of the first symmetry center coordinate and the second symmetry center coordinate, wherein
each line pattern region of the first line pattern region group has a different pattern density for each line pattern region, and
each line pattern region of the second line pattern region group has a different pattern density for each line pattern region.

16. The overlay measuring method according to claim 15, further comprising:
irradiating a fifth overlay measurement mark formed by using the first layer so that each line pattern region of a third line pattern region group extends in a direction parallel to the second direction with a third space pattern region therebetween in the substrate surface, and a sixth overlay measurement mark that is formed by using the first layer and has point-symmetry with the fifth overlay measurement mark, with illumination light and receiving reflected light from the fifth and sixth overlay measurement marks, and irradiating a seventh overlay measurement mark formed by using the second layer so that each line pattern region of a fourth line pattern region group extends in a direction parallel to the second direction with a fourth space pattern region therebetween in the substrate surface, and an eighth overlay measurement mark that is formed by using the second layer and has point-symmetry with the seventh overlay measurement mark, with illumination light and receiving reflected light from the seventh and eighth overlay measurement marks;
calculating a third symmetry center coordinate with respect to the fifth and sixth overlay measurement marks in the first direction in the substrate surface on a basis of an intensity profile of reflected light from the fifth and sixth overlay measurement marks, and calculating a fourth symmetry center coordinate with respect to the seventh and eighth overlay measurement marks in the first direction in the substrate surface on a basis of an intensity profile of reflected light from the seventh and eighth overlay measurement marks; and
calculating an overlay displacement amount in the first direction between a pattern formed by using the first layer and a pattern formed by using the second layer on a basis of the third symmetry center coordinate and the fourth symmetry center coordinate, wherein
each line pattern region of the third line pattern region group has a different pattern density for each line pattern region, and
each line pattern region of the fourth line pattern region group has a different pattern density for each line pattern region.

17. The overlay measuring method according to claim 15, wherein, a plurality of line patterns is arranged in each line pattern region of the first and second line pattern region groups.

18. The overlay measuring method according to claim 17, wherein, the line patterns include two or more line patterns having a space width or a pattern width different from each other between the line pattern regions.

19. The overlay measuring method according to claim 16, wherein the first to eighth overlay measurement marks are a line and space type mark.

20. The overlay measuring method according to claim 16, wherein the first to eighth overlay measurement marks are a bar-in-bar type mark.
